(19) United States
(12) Patent Application Publication
(10) Pub. No.: US 2020/0076265 A1
(43) Pub. Date: Mar. 5, 2020

(54) INSULATION BOBBIN AND STATOR UNIT STRUCTURE AND SERVO-MOTOR STRUCTURE USING THE SAME

(71) Applicants: LITE-ON ELECTRONICS (GUANGZHOU) LIMITED, GUANGZHOU (CN); LITE-ON TECHNOLOGY CORPORATION, Taipei (TW)

(72) Inventors: Wei-Min Tsao, Taipei (TW); Chun-Lung Ho, Taipei (TW)

(21) Appl. No.: 16/540,926

(22) Filed: Aug. 14, 2019

(30) Foreign Application Priority Data
Sep. 5, 2018 (CN) 201811033138.6

(51) Int. Cl. H02K 3/50; H01F 27/32; H02K 3/34; H02K 1/16

(52) U.S. Cl. CPC H02K 3/50; H02K 1/16; H02K 3/345; H01F 27/325

(57) ABSTRACT

An insulation bobbin is provided. The insulation bobbin includes a winding portion, an outer stopper and an inner stopper. The winding portion has an outer side and an inner side. The outer stopper is connected with the outer side of the winding portion. The outer stopper has a top surface. The outer stopper includes two notches extending downward from the top surface. Each of the two notches has a cross-sectional area substantially being a combination of a circle and a rectangle. The inner stopper is connected with the inner side of the winding portion.

This application claims the benefit of People's Republic of China application Serial No. 201811033138.6, filed Sep. 5, 2018, the subject matter of which is incorporated herein by reference.

### BACKGROUND OF THE INVENTION

### Field of the Invention

The invention relates in general to an insulation bobbin, and a stator unit structure and a server motor structure using the same, and more particularly to an insulation bobbin with universal notches, and a stator unit structure and a server motor structure using the same.

### Description of the Related Art

The motor, capable of converting electric energy into mechanic energy, has been widely used in various products, such as lathes, transmission devices, and robots. Normally, the motor includes a stator structure and a rotor structure. The stator structure is winded with a coil. When an electric current passes through a coil, a magnetic field will be generated around the rotor structure. Then, the magnetic field drives the rotor structure to rotate and convert electric energy into mechanic energy. To be adapted to the application in various products, the structure of the motor can be adjusted. However, if the structure of the motor needs to be customized and a universal structure cannot be used, the manufacturing process will become more complicated and the manufacturing cost will increase.

### SUMMARY OF THE INVENTION

According to the embodiments of the present invention, the insulation bobbin for the motor are adjustable, and a universal notch structure compactible with different types of pins is provided.

According to one embodiment of the present invention, an insulation bobbin is provided. The insulation bobbin includes a winding portion, an outer stopper, and an inner stopper. The winding portion has an outer side and an inner side. The outer stopper is connected with the outer side of the winding portion. The outer stopper has a top surface. The outer stopper includes two notches extended downward from the top surface. Each notch has a cross-section substantially being a combination of a circle and a rectangle. The inner stopper is connected with the inner side of the winding portion.

According to another embodiment of the present invention, a stator unit structure is provided. The stator unit structure includes a metal core and two insulation bobbins. The two insulation bobbins are respectively disposed at the two ends of the metal core. Each insulation bobbin includes a winding portion, an outer stopper, and an inner stopper. The winding portion has an outer side and an inner side. The outer stopper is connected with the outer side of the winding portion. The outer stopper has a top surface. The outer stopper includes two notches extended downward from the top surface. Each notch has a cross-section substantially being a combination of a circle and a rectangle. The inner stopper is connected with the inner side of the winding portion.

According to an alternate embodiment of the present invention, a server motor structure is provided. The server motor structure includes the stator unit structure disclosed in any embodiment.

The insulation bobbin of the present invention provides a universal notch structure compactible with different types of pins. Even when the universal notch structure is used in cooperation with different types of cylindrical pins or rectangular pins, there is no need to change the whole design of the insulation bobbin. Therefore, the insulation bobbin compactible with different types of pins can be manufactured using single type of mold. For the stator unit structure and the server motor structure using the same, the manufacturing process also can be simplified and the manufacturing cost can be reduced.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a three-dimensional diagram of an insulation bobbin according to an embodiment.

FIG. 1B is a top view of an insulation bobbin according to an embodiment.

FIG. 1C is a cross-sectional view of an insulation bobbin viewed along the middle line 1C-1C′ of FIG. 1A according to an embodiment.

FIG. 2A is an exploded diagram of a stator unit structure according to an embodiment.

FIG. 2B is a three-dimensional diagram of a stator unit structure according to an embodiment.

FIG. 3A is an exploded diagram of a stator unit structure according to another embodiment.

FIG. 3B is an exploded diagram of a stator unit structure according to another embodiment.

FIG. 4 is a schematic diagram of a server motor structure according to an embodiment.

### DETAILED DESCRIPTION OF THE INVENTION

The present invention is disclosed below with reference to accompanying drawings. It should be understood that the accompanying drawings and related descriptions are for exemplary and explanatory purposes only, not for limiting the scope of protection of the present invention. For example, the elements illustrated in the accompanying drawings may not be based on actual proportion of the product. Moreover, as it can be expected that the elements, conditions and features disclosed in an embodiment can also be advantageously adapted in another embodiment, but no further exemplification is disclosed.

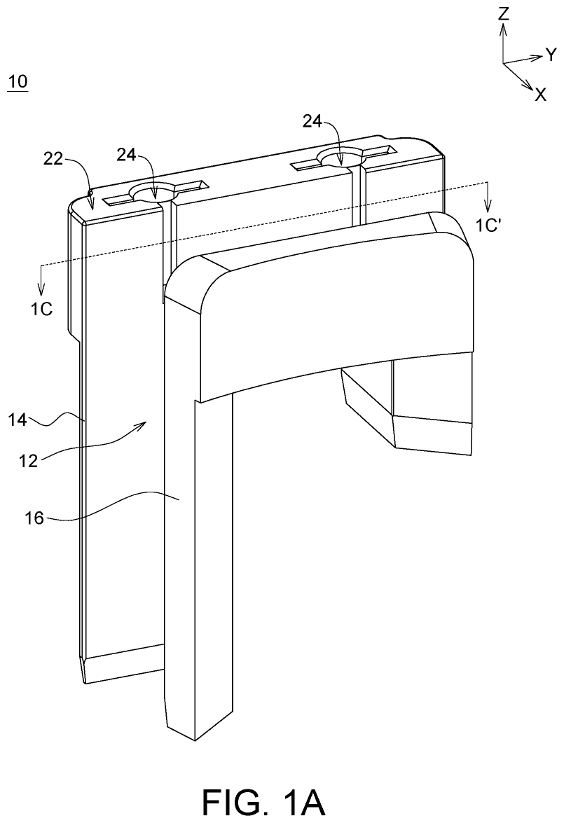

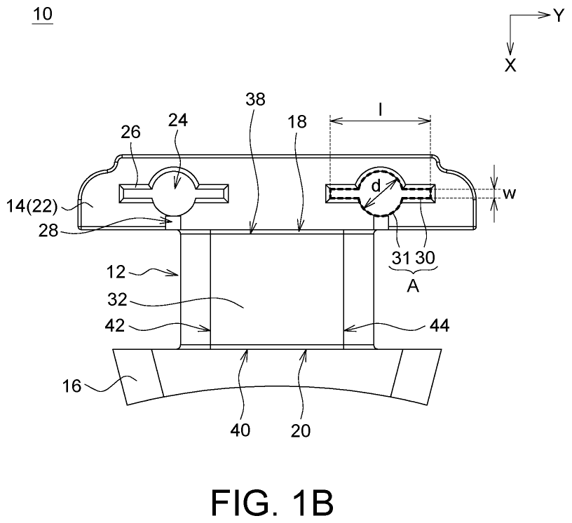

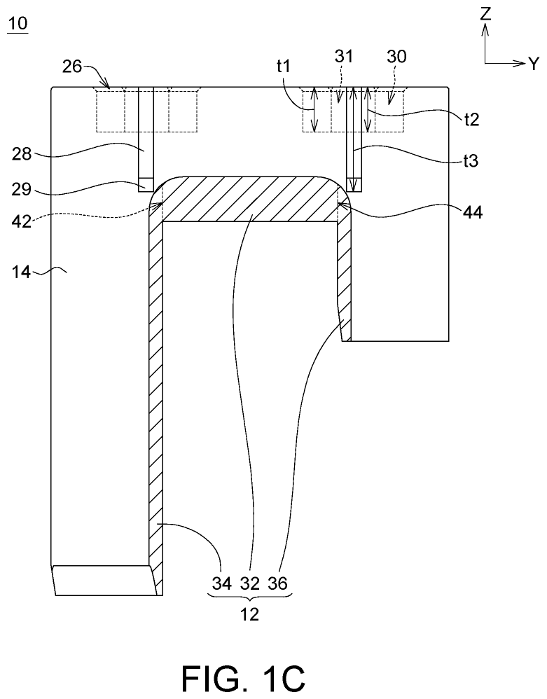

Referring to FIGS. 1A-1C, diagrams of an insulation bobbin 10 according to an embodiment are shown. FIG. 1A is a three-dimensional diagram of an insulation bobbin 10 according to an embodiment. FIG. 1B is a top view of an insulation bobbin 10 according to an embodiment. FIG. 1C is a cross-sectional view of an insulation bobbin 10 viewed along the middle line 1C-1C′ of FIG. 1 A according to an embodiment.

The insulation bobbin 10 includes a winding portion 12, an outer stopper 14, and an inner stopper 16. The winding portion 12 has an outer side 18 and an inner side 20. The outer stopper 14 is connected with the outer side 18 of the winding portion 12. The outer stopper 14 has a top surface 22. Two notches 24 of the outer stopper 14 are extended downward from the top surface 22, and respectively have a cross-section A substantially being a combination of a circle and a rectangle. Here, the expression “substantially” means that despite the notches 24 may include other parts, such as the chamfer 26 or the lead receiving slot 28, the user still can easily identify the notches 24 and exclude these other parts. Each notch 24 has a cross-section

A substantially being a combination of a circle and a rectangle. The inner stopper 16 is connected with the inner side 20 of the winding portion 12.

In some embodiments, as indicated in FIG. 1B, the cross-section A of each notch 24 is substantially a combination of a circle and a rectangle sharing the same center. The part of each notch 24 corresponding to the rectangle 30 of the cross-section A has a depth t1. The part of each notch 24 corresponding to the circle 31 of the cross-section A has a depth t2. The depth t1 can be equivalent to depth t2. The depth of each notch 24 is not subjected to specific restrictions. For example, the depth t2 can be greater than the depth t1 if the circle 31 is received with a longer cylindrical pin.

In some embodiments, to facilitate the insertion of pins, the junction between each notch 24 and the top surface 22 can have a chamfer 26 formed along the cross-section A. The pattern of the chamfer 26 is not subjected to specific restrictions. For example, the chamfer 26 can correspond to only a part of the cross-section A, such as the rectangle 30 of the cross-section A, or can correspond to the entire cross-section A, including the rectangle 30 and the circle 31.

In some embodiments, to facilitate the connection of coil, each notch 24 can further include a lead receiving slot 28 extended downward from the top surface 22 and interconnected with the part of the notch 24 corresponding to the circle 31 of the cross-section A. The lead receiving slot 28 of each notch 24 has a depth t3. To provide a better guiding effect at the terminal end of the coil, the depth t3 can be greater than the depth t1 of the rectangle 30 or the depth t2 of the circle 31 of the cross-section A of each notch 24. To provide a better guiding effect at the terminal end of the coil, each slot 28 can have a bevel 29 extended towards the outer bottom of the lead receiving slot 28, that is, towards the winding portion 12.

In some embodiments, the winding portion 12 includes a winding platform 32, a first extension portion 34, and a second extension portion 36. As indicated in FIG. 1 B, the winding platform 32 has a first side 38, a second side 40, a third side 42, and a fourth side 44. The first side 38 and the second side 40 are disposed oppositely; the first side 38 and the second side 40 are respectively located between the outer side 18 and the inner side 20 of the winding portion 12; the third side 42 and the fourth side 44 are disposed oppositely. The first extension portion 34 is connected with the third side 42 of the winding platform 32 and extended farther away from the top surface 22. The second extension portion 36 is connected with the fourth side 44 of the winding platform 32 and extended farther away from the top surface 22. The first extension portion 34 and the second extension portion 36 are spaced apart from each other. In some embodiments, as indicated in FIG. 10, the length of the first extension portion 34 can be not equivalent to that of the second extension portion 36.

In some embodiments, as indicated in FIG. 1A, the outer stopper 14 and the inner stopper 16 can be protruded and higher than the winding portion 12, particularly the winding platform 32, to facilitate the winding of coil 64.

The insulation bobbin 10 can be formed of plastics, particularly voltage withstanding and insulating plastics. In some embodiments, the said plastics complies with the requirements listed in Table 1, and can be realized by such as DR 48 (PBT) plastics. Given that the insulation bobbin 10 is formed of plastics, the aperture size of each notch 24 can be less than that of a corresponding pin. The flexibility of plastics allows slight deformation, and is able to receive and tightly fix the pin. Specifically, the circle 31 of the cross-section A of each notch 24 has a diameter d. Before the pins are inserted into the two notches 24, the diameter d is less than a diameter of the cylindrical pins to be inserted to the two notches 24. Alternately or additionally, the rectangle 30 of the cross-section A of each notch 24 has a length I and a width w. Before the pins are inserted to the two notches 24, the length I and the width w are respectively less than a length and a width of the rectangular pins to be inserted to the two notches 24. In some embodiments, the insulation bobbin 10 can be integrally formed in one piece.

TABLE 1

| Electrical Performance | Value | Test Method |
|---|---|---|
| Hot Wire Ignition (HWI) | | UL 746 |
| 0.710 mm | PLC3 | |
| 1.50 mm | PLC3 | |
| 3.00 mm | PLC3 | |
| 6.00 mm | PLC2 | |
| High Amp Arc Ignition (HAI) | | UL 746 |
| 0.710 mm | PLC0 | |
| 1.50 mm | PLC0 | |
| 3.00 mm | PLC0 | |
| 6.00 mm | PLC0 | |
| Comparative Tracking Index | PLC3 | UL 746 |
| (CTI) | | |
| Dielectric Strength | 29 kV/mm | ASTM D149 |
| | | IEC 60243-1 |
| High Voltage Tracking | PLC4 | UL 746 |
| Resistance (HVTR) | | |
| Volume Resistivity | 1.0E+15 ohms · cm | ASTM D257 |
| | | IEC 60093 |
| Arc Resistance | PLC7 | ASTM D495 |

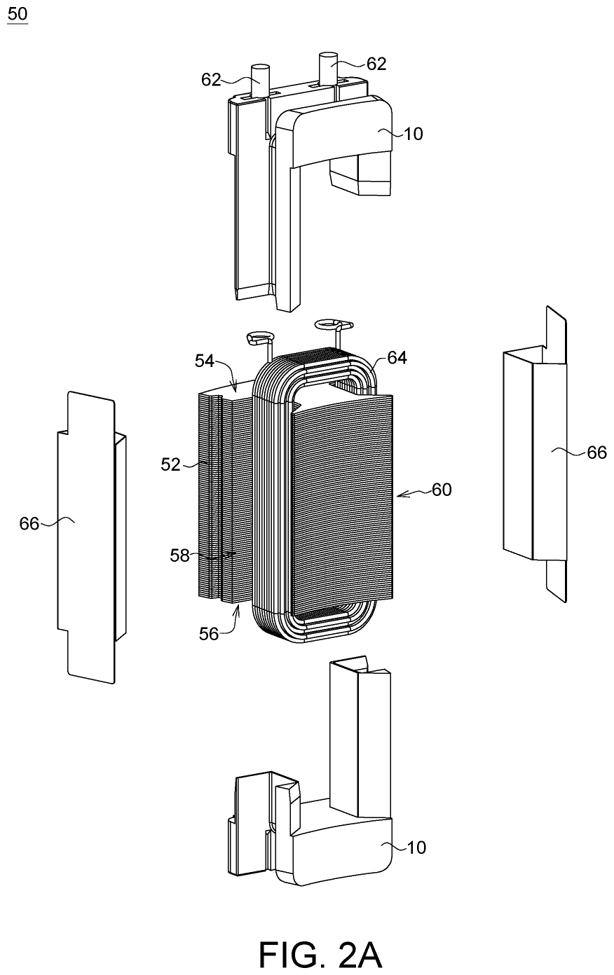

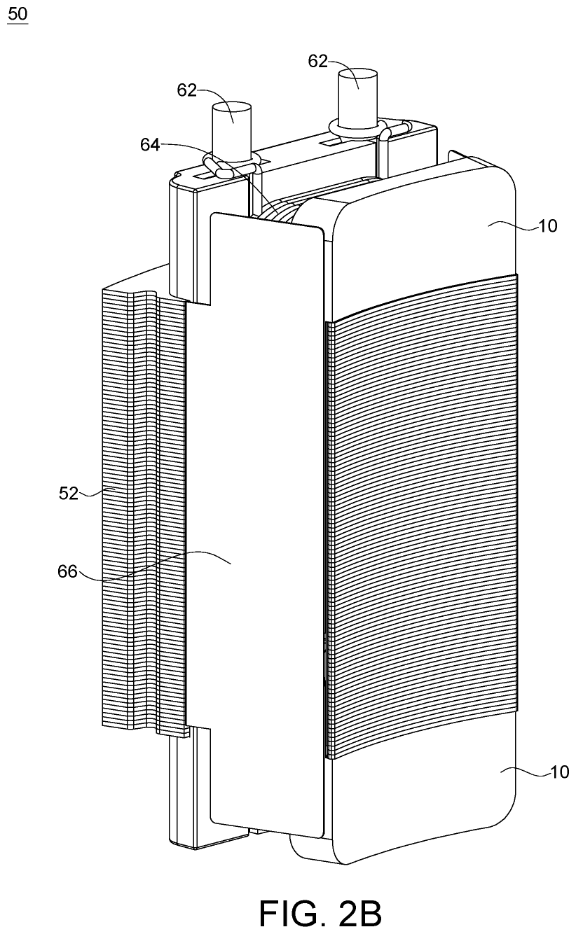

Referring to FIGS. 2A-2B, diagrams of a stator unit structure 50 according to an embodiment are shown. FIG. 2A is an exploded diagram of a stator unit structure 50 according to an embodiment. FIG. 2B is a three-dimensional diagram of a stator unit structure 50 according to an embodiment. The stator unit structure 50 includes a metal core 52 and two insulation bobbins 10. The metal core 52 has two ends, that is, a first end 54 and a second end 56. The two insulation bobbins 10 are respectively disposed at the first end 54 and the second end 56 of the metal core 52. One of the two insulation bobbins 10 disposed atop and the other one of the two insulation bobbins 10 disposed underneath are disposed oppositely, such that the first extension portion 34 of one of the insulation bobbins 10 disposed atop corresponds to the second extension portion 36 of the other one of the insulation bobbins 10 disposed underneath, and the second extension portion 36 of one of the insulation bobbins 10 disposed atop corresponds to the first extension portion 34 of the other one of the insulation bobbins 10 disposed underneath. Refer to FIGS. 1A-1C. Each insulation bobbin 10 includes a winding portion 12, an outer stopper 14, and an inner stopper 16. The winding portion 12 has an outer side 18 and an inner side 20. The outer stopper 14 is connected with the outer side 18 of the winding portion 12. The outer stopper 14 has a top surface 22. The outer stopper 14 includes two notches 24 extended downward from the top surface 22. Each notch 24 have a cross-section A substantially being a combination of a circle and a rectangle. The inner stopper 16 is connected with the inner side 20 of the winding portion 12. Furthermore, the insulation bobbin 10 may possess features disclosed in any of the above embodiments. In some embodiments, the metal core 52 has a first indented portion 58 and a second indented portion 60, which are located at a connecting portion which is connected to the two ends of the metal core 52 (that is, the first end 54 and the second end 56). The winding portion 12 has a winding platform 32. A first extension portion 34 and a second extension portion 36 are respectively extended from the two sides of the winding platform 32. The first extension portion 34 and the second extension portion 36 are respectively extended to the first indented portion 58 and the second indented portion 60.

In some embodiments, the stator unit structure 50 may further include two pins 62, a coil 64, and two flexible insulation films 66. The two pins 62 are respectively inserted into the two notches 24 of one of the two insulation bobbins 10. For example, the two pins 62 are inserted into the two notches 24 of the insulation bobbin 10 disposed at the first end 54 of the metal core 52. Each of the two pins 62 used in the stator unit structure 50 has a circular cross-section. Here, the pin 62 having a circular cross-section is referred as a cylindrical pin, and is normally used for coupling the circuit board.

Such arrangement can be used in a 1 kW server motor but is not limited thereto. The coil 64 is winded on the two insulation bobbins 10 along the first extension portion 34, the winding platform 32 and the second extension portion 36. The coil 64 is electrically connected with two pins 62. The two flexible insulation films 66 respectively cover the first indented portion 58 and the second indented portion 60 for separating the coil 64 from the metal core 52. Besides, through the first indented portion 58 and the second indented portion 60, which cover the metal core 52, the flexible insulation films 66 can further electrically isolate the coil 64 of two adjacent stator unit structures 50.

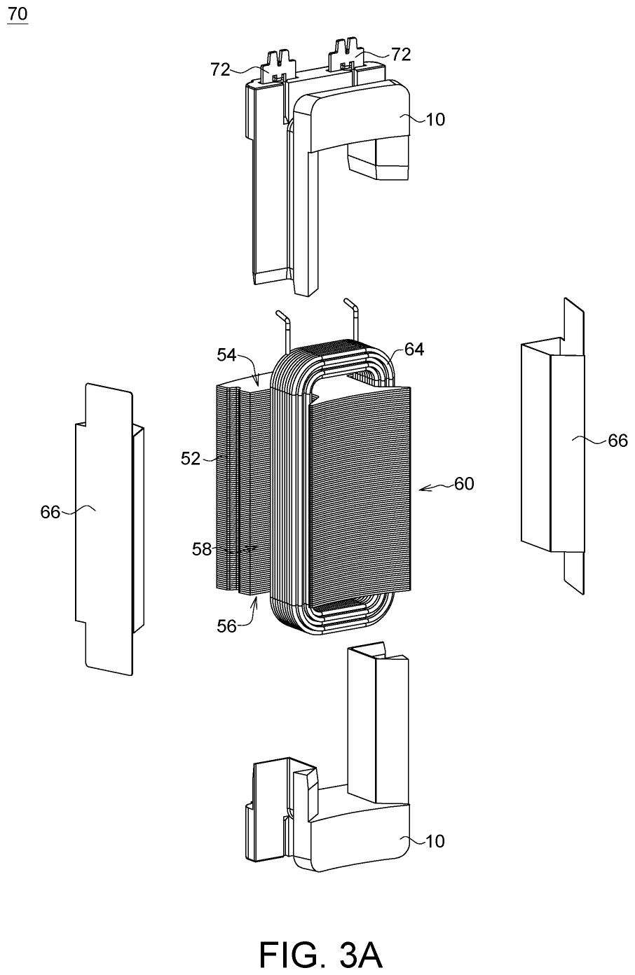

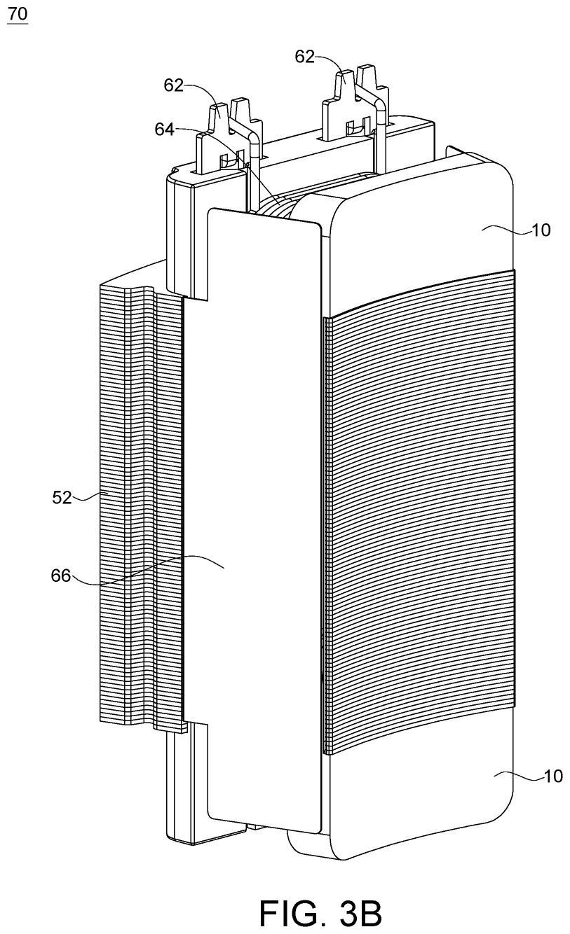

Referring to FIGS. 3A-3B, diagrams of a stator unit structure 70 according to another embodiment are shown. FIG. 3A is an exploded diagram of a stator unit structure 70 according to another embodiment. FIG. 3B is an exploded diagram of a stator unit structure 70 according to another embodiment. Each of the two pins 72 used in the stator unit structure 70 has a rectangular cross-section. Here, the pin 72 having a rectangular cross-section is referred as a rectangular pin, and is normally used in manual winding. Such arrangement can be used in a 2 kW server motor but is not limited thereto. Other details of the stator unit structure 70 are similar to that of the stator unit structure 50, and are not repeated here.

It can be understood that the insulation bobbin 10 of the above embodiments provides a universal notch 24 compactible with different types of pins. As indicated in FIG. 2A-2B and FIG. 3A-3B, even when the universal notch structure is used in cooperation with different types of cylindrical pins 62 and rectangular pins 72, there is no need to change the whole design of the insulation bobbin 10. Therefore, the insulation bobbin compactible with different types of pins can be manufactured using single type of mold. For the stator unit structure and the server motor structure using the same, the manufacturing process can be simplified and the manufacturing cost can be reduced.

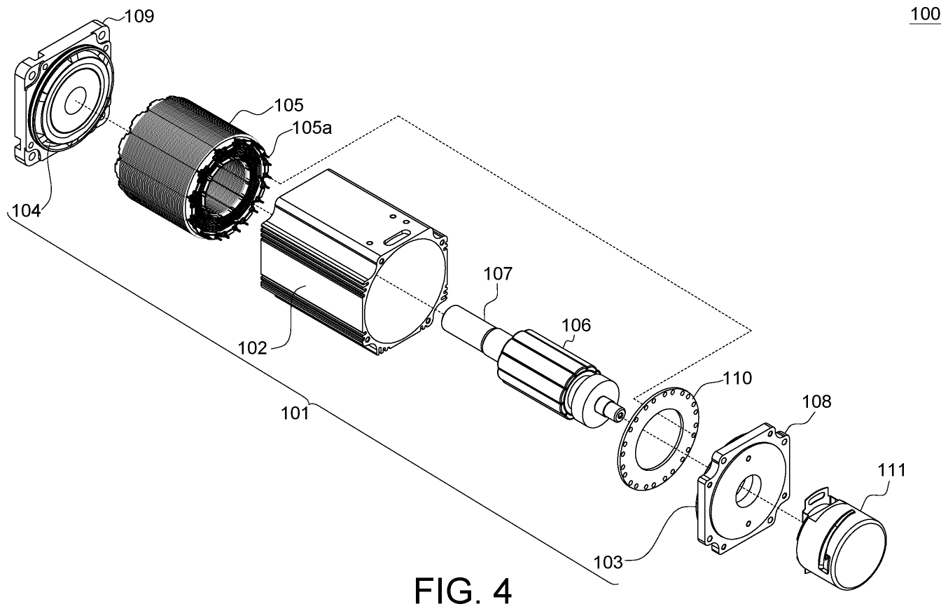

Referring to FIG. 4, a schematic diagram of a server motor structure 100 according to an embodiment is shown. The server motor structure 100 includes the stator unit structure according to any of the above embodiments. Specifically, the server motor structure 100 includes a casing 101. The casing 101 includes a hollowed body 102, a first bearing 103, and a second bearing 104. The hollowed body 102 is coupled between the first bearing 103 and the second bearing 104. The server motor structure 100 further includes a stator assembly structure 105 and a rotor structure 106. The stator assembly structure 105 is disposed in the hollowed body 102. The stator assembly structure 105 includes a plurality of stator unit structures, such as stator unit structures 50 or stator unit structures 70. The said stator unit structures form a surrounding space, in which the rotor structure 106 is disposed. The rotor structure 106 includes a shaft 107, which couples the first bearing 102 and the second bearing 103. In some embodiments, the casing may further include a first bearing fixer 108 and a second bearing fixer 109, by which the lathes, the transmission devices, the robots using the server motor are fixed. Here, the pins 105a used in the stator assembly structure 105 are exemplified by cylindrical pins. The cylindrical pins couple the circuit board 110, and are further electrically connected with the control unit 111 of the server motor structure 100. It can be understood that the rectangular pins can also be electrically connected with the control unit 111. Moreover, the server motor structure 100 is for exemplary purpose only, and the insulation bobbin 10 of the embodiments and the stator unit structure using the same can be used in cooperation with any compactible server motor structures.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An insulation bobbin, comprising:
a winding portion having an outer side and an inner side;
an outer stopper connected with the outer side of the winding portion, wherein the outer stopper has a top surface, and comprises:
two notches extended downward from the top surface, wherein each notch has a cross-section substantially being a combination of a circle and a rectangle; and
an inner stopper connected with the inner side of the winding portion.

2. The insulation bobbin according to claim 1, wherein the cross-section of each of the two notches is substantially a combination of the circle and the rectangle sharing the same center.

3. The insulation bobbin according to claim 1, wherein a chamfer is formed at a junction between the top surface and each of the two notches along the cross-section.

4. The insulation bobbin according to claim 1, wherein each of the two notches further comprises a lead receiving slot extended downward from the top surface and interconnected with the circle of the cross-section.

5. The insulation bobbin according to claim 4, wherein the lead receiving slot has a depth greater than a depth of of the part of the notch corresponding to the cross-section.

6. The insulation bobbin according to claim 1, wherein the circle of the cross-section has a diameter, and the diameter of the circle is less than a diameter of a cylindrical pin.

7. The insulation bobbin according to claim 1, wherein the rectangle of the cross-section has a length and a width, the length and the width of the rectangle are respectively less than a length and a width of a rectangular pin.

8. The insulation bobbin according to claim 1, wherein the winding portion comprises:
a winding platform having a first side, a second side, a third side, and a fourth side, wherein the first side and the second side are disposed oppositely and respectively located on the outer side and the inner side of the winding portion; the third side and the fourth side are disposed oppositely;
a first extension portion connected with the third side of the winding platform and extended farther away from the top surface; and
a second extension portion connected with the fourth side of the winding platform and extended farther away from the top surface, wherein the first extension portion and the second extension portion are spaced apart from each other.

9. The insulation bobbin according to claim 8, wherein the length of the first extension portion is not equivalent to that of the second extension portion.

10. A stator unit structure, comprising:
a metal core; and
two insulation bobbins respectively disposed at two ends of the metal core, wherein each of the two insulation bobbin comprises:
a winding portion having an outer side and an inner side;
an outer stopper connected with the outer side of the winding portion, wherein the outer stopper has a top surface and comprises:
two notches extended downward from the top surface, wherein each of the two notches has a cross-section substantially being a combination of a circle and a rectangle; and
an inner stopper connected with the inner side of the winding portion.

11. The stator unit structure according to claim 10, wherein the metal core has a first indented portion and a second indented portion, the first indented portion and the second indented portion are located at a connecting portion which is connected to the two ends of the metal core; the winding portion has a winding platform, a first extension portion and a second extension portion, the first extension portion and the second extension portion respectively extended from two sides of the winding platform are respectively extend to the first indented portion and the second indented portion; the stator unit structure further comprises:
two pins respectively inserted into the two notches of one of the two insulation bobbins, wherein each of the two pins has a circular cross-section or a rectangular cross-section;
a coil winded on the two insulation bobbins along the first extension portion, the winding platform and the second extension portion, and the coil electrically connect the two pins; and
two flexible insulation films respectively covering the first indented portion and the second indented portion to separate the coil from the metal core.

12. A server motor structure, comprising the stator unit structure according to claim 10.

13. A server motor structure, comprising the stator unit structure according to claim 11.
